(19) United States
(12) Patent Application Publication
(10) Pub. No.: US 2023/0202332 A1
(43) Pub. Date: Jun. 29, 2023

(54) ELECTRONIC DEVICE THAT MANAGES ENERGY WITH A SIMPLIFIED BUTTON OPERATION, AN OPERATION METHOD THEREOF

(71) Applicant: ELECTRONICS AND TELECOMMUNICATIONS RESEARCH INSTITUTE, Daejeon (KR)

(72) Inventor: Seok-jin LEE, Daejeon (KR)

(21) Appl. No.: 18/063,892

(22) Filed: Dec. 9, 2022

(30) Foreign Application Priority Data
Dec. 23, 2021 (KR) 10-2021-0185842
Oct. 28, 2022 (KR) 10-2022-0141697

(51) Int. Cl. B60L 53/62; H02J 3/00; B60L 53/30

(52) U.S. Cl. CPC B60L 53/62; H02J 3/003; B60L 53/305; H02J 2203/20

(57) ABSTRACT

Provided is an electronic device for managing energy with a simplified button operation, and an operating method thereof. The method of operating the electronic device includes displaying a charging time, which is required for charging completion of a charging target load device that a user desires to charge, and a charging demand, which is required for charging, by using a profile related to energy use of the user, receiving, from the user, an increase command, a determination command, or a decrease command, and when a received command is the increase command or the decrease command, performing an increase or a decrease in one of the charging time and the charging demand or the combination of two or more thereof, according to the increase command or the decrease command, based on an increase rate or a decrease rate using a change rate calculated through a change rate calculation model.

### CROSS-REFERENCE TO RELATED APPLICATION

This application claims the benefit of Korean Patent Application No. 10-2021-0185842 filed on Dec. 23, 2021, and Korean Patent Application No. 10-2022-0141697 filed on Oct. 28, 2022, in the Korean Intellectual Property Office, the entire disclosures of which are incorporated herein by reference for all purposes.

### BACKGROUND

### 1. Field of the Invention

The present disclosure relates to an electronic device for managing energy with a simplified button operation and a method of operating the electronic device.

### 2. Description of the Related Art

Power supply equipment must be able to withstand peak loads. Electricity may be sensitive to the balance of supply and demand. Balancing supply and demand may require significant investment in supply facilities. In this case, the management of a peak load and a consumer in parallel with the investment in the supply facilities may further improve an efficiency in balancing supply and demand. Therefore, the demand may need to be managed.

Demand management may refer to plans and activities in which a supplier reasonably controls and adjusts a consumer's electricity use. Demand management may include greater efficiency of a device using power and demand response from consumers. Response from consumers with respect to demand management may be the demand response. The demand response may be a change in the consumption patterns of consumers who desire cost saving.

### SUMMARY

Embodiments provide an electronic device for managing energy with a simplified button operation, to reach the amount of a charging demand and a charging time that a consumer, who uses power, desires with a minimum button input.

According to an aspect, there is provided an operating method of an electronic device including: displaying a charging time, which may be required for charging completion of a charging target load device that a user desires to charge, and a charging demand, which may be required for charging, by using a profile related to energy use of the user; receiving, from the user, an increase command, a determination command, or a decrease command for one of the charging time and the charging demand or a combination of two or more thereof, through an increase button, a determination button, or a decrease button; when a received command is the increase command or the decrease command, performing an increase or a decrease in one of the charging time and the charging demand or the combination of two or more thereof, according to the increase command or the decrease command, based on an increase rate or a decrease rate using a change rate calculated through a change rate calculation model; and when a received command is the determination command, generating a charging start command to charge the charging target load device, according to a current charging time and a current charging demand.

According to an embodiment, the change rate calculation model may be a learned model to calculate the change rate according to an input of the increase button or an input of the decrease button so as to reach the current charging time and the current charging demand that the user desires to select, with a minimum selection with respect to the increase button or the decrease button.

According to an embodiment, the change rate calculation model may be a learned model to calculate the change rate according to an input of the increase button or an input of the decrease button, with an input of information about a feedback score, information about a number of button inputs, and information about a simultaneous trend.

According to an embodiment, the change rate calculation model may be a learned model to calculate the change rate according to an input of the increase button or an input of the decrease button, with an input of information about a feedback score, information about a number of button inputs, and information about a simultaneous trend.

According to an embodiment, the information about the feedback score may be feedback information received from the user after the electronic device performs the operating method, the information about the number of button inputs may be information about a number of inputs of the increase button or a number of inputs of the decrease button to reach the current charging time and the current charging demand that the user desires to select, and the information about the simultaneous trend may be information about the charging time and the charging demand of other users who charge a load device of a same type as the charging target load device that the user desires to charge at a same time.

According to an embodiment, the change rate calculation model may be a learned model from a central management server communicating with the electronic device and a model in which the learned model is upgraded to the electronic device.

According to an embodiment, the performing of the increase or the decrease may include receiving the information about the feedback score, the information about the number of button inputs, and the information about the simultaneous trend; inputting the information about the feedback score, the information about the number of button inputs, and the information about the simultaneous trend to the change rate calculation model; calculating the increase rate or the decrease rate by multiplying an initial value by the change rate, which is a result value that the charge rate calculation model outputs according to an input. The initial value may be a predetermined value to perform an increase or a decrease in one of the charging time and the charging demand or a combination of two or more thereof, under the increase command or the decrease command, regardless of the change rate calculation model; and performing an increase or a decrease under the increase command or the decrease command according to the increase rate or the decrease rate.

According to an embodiment, the profile related to the energy use of the user may be a history of a time used for charging the charging target load device of the user during a specific period and of a charging demand used for charging the charging target load device.

According to an embodiment, when the electronic device includes a charging interface connected to a control module of the charging target load device and the electronic device is connected to the charging target load device through the charging interface, the operating method of the electronic device may further include charging the charging target load device according to the charging start command.

According to an embodiment, when the electronic device does not include a charging interface connected to a control module of the charging target load device, the operating method of the electronic device may further include transmitting the charging start command to a charger interlocked with the electronic device. The charger receiving the charging start command may be configured to charge the charging target load device connected to the charger.

According to an aspect, there is provided an electronic device including: a memory including a change rate calculation model; and a processor configured to display a charging time, which is required for charging completion of a charging target load device that a user desires to charge, and a charging demand, which is required for charging, by using a profile related to energy use of the user, receive, from the user, an increase command, a determination command, or a decrease command for one of the charging time and the charging demand or a combination of two or more thereof, through an increase button, a determination button, or a decrease button, when a received command is the increase command or the decrease command, perform an increase or a decrease in one of the charging time and the charging demand or a combination of two or more thereof, according to the increase command or the decrease command, based on an increase rate or a decrease rate using a change rate calculated by the change rate calculation model, and when a received command is the determination command, generate a charging start command to charge the charging target load device according to a current charging time and a current charging demand.

According to an embodiment, the current charging time and the current charging demand may be, when the increase command or the decrease command is received before receipt of the determination command, values in which one of the charging time and the charging demand or the combination of two or more thereof is increased or decreased by the increase rate or the decrease rate and, when the increase command or the decrease command is not received before receipt of the determination command, the charging time and the charging demand, respectively.

According to an embodiment, the change rate calculation model may be a learned model to calculate the change rate according to an input of the increase button or an input of the decrease button so as to reach the current charging time and the current charging demand that the user desires to select, with a minimum selection with respect to the increase button or the decrease button.

According to an embodiment, the change rate calculation model may be a learned model to calculate the change rate according to an input of the increase button or an input of the decrease button, with an input of information about a feedback score, information about a number of button inputs, and information about a simultaneous trend.

According to an embodiment, the information about the feedback score may be feedback information received from the user according to an operation of the electronic device, the information about the number of button inputs may be information about a number of inputs of the increase button or a number of inputs of the decrease button to reach the current charging time and the current charging demand that the user desires to select, and the information about the simultaneous trend may be information about the charging time and the charging demand of other users who charge a load device of a same type as the charging target load device that the user desires to charge at a same time.

According to an embodiment, the change rate calculation model may be a learned model from a central management server communicating with the electronic device and a model in which the learned model is upgraded to the electronic device.

According to an embodiment, the processor may be configured to receive the information about the feedback score, the information about the number of button inputs, and the information about the simultaneous trend, from a central management server communicating with the electronic device, input the information about the feedback score, the information about the number of button inputs, and the information about the simultaneous trend to the change rate calculation model, calculate the increase rate or the decrease rate by multiplying an initial value by the change rate, which is a result value that the change rate calculation model outputs according to an input. The initial value may be a predetermined value to perform an increase or a decrease in one of the charging time and the charging demand or a combination of two or more thereof, under the increase command or the decrease command, regardless of the change rate calculation model, and perform an increase or a decrease under the increase command or the decrease command according to the increase rate or the decrease rate.

According to an embodiment, the profile related to the energy use of the user may be a history of a time used for charging the charging target load device of the user during a specific period and of a charging demand used for charging the charging target load device.

According to an embodiment, when the electronic device does not include a charging interface connected to a control module of the charging target load device, the processor may be configured to transmit the charging start command to a charger interlocked with the electronic device, and the charger receiving the charging start command may be configured to charge the charging target load device connected to the charger.

According to an aspect, there is provided an electronic device including: a memory including a change rate calculation model; and a processor configured to display a charging time, which is required for charging completion of a charging target load device that a user desires to charge, and a charging demand, which is required for charging, by using a profile related to energy use of the user, receive, from the user, an increase command, a determination command, or a decrease command for one of the charging time and the charging demand or a combination of two or more thereof, through an increase button, a determination button, or a decrease button, when a received command is the increase command or the decrease command, transmit the increase command or the decrease command to a central management server communicating with the electronic device, and, when a received command is the determination command, generate a charging start command to charge the charging target load device, according to a current charging time and a current charging demand. The model management server may be configured to, when the increase command or the decrease command is received from the electronic device, calculate a change rate, using a change rate calculation model, to reach the current charging time and the current charging demand, which the user desires to select, with a minimum selection of the increase button or the decrease button.

Additional aspects of embodiments will be set forth in part in the description which follows and, in part, will be apparent from the description, or may be learned by practice of the disclosure.

According to embodiments, a charging demand and a charging time that a consumer desires may be reached by using an electronic device that manages energy with a simplified button operation.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an electronic device according to an embodiment;

FIGS. 2A and 2B are diagrams illustrating distributed charging according to an embodiment;

FIG. 3 is a flowchart illustrating an operation of an electronic device according to an embodiment;

FIG. 4 is a flowchart illustrating an operation of an electronic device according to an embodiment;

FIG. 5 is a diagram illustrating a change rate calculation model according to an embodiment;

FIG. 6 is a diagram illustrating an operation of a change rate calculation model according to an embodiment; and

FIG. 7 is a diagram illustrating a button capable of receiving a command from a user, according to an embodiment.

### DETAILED DESCRIPTION

Hereinafter, embodiments will be described in detail with reference to the accompanying drawings. The scope of the right, however, should not be construed as limited to the embodiments set forth herein. In the drawings, like reference numerals are used for like elements.

Various modifications may be made to the embodiments. Here, the embodiments are not construed as limited to the disclosure and should be understood to include all changes, equivalents, and replacements within the idea and the technical scope of the disclosure. Although terms of “first” or “second” are used to explain various components, the components are not limited to the terms. These terms should be used only to distinguish one component from another component. For example, a first component may be referred to as a second component, and similarly the second component may also be referred to as the first component.

The terminology used herein is for the purpose of describing particular embodiments only and is not to be limiting of the embodiments. As used herein, the singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Hereinafter, embodiments will be described in detail with reference to the accompanying drawings.

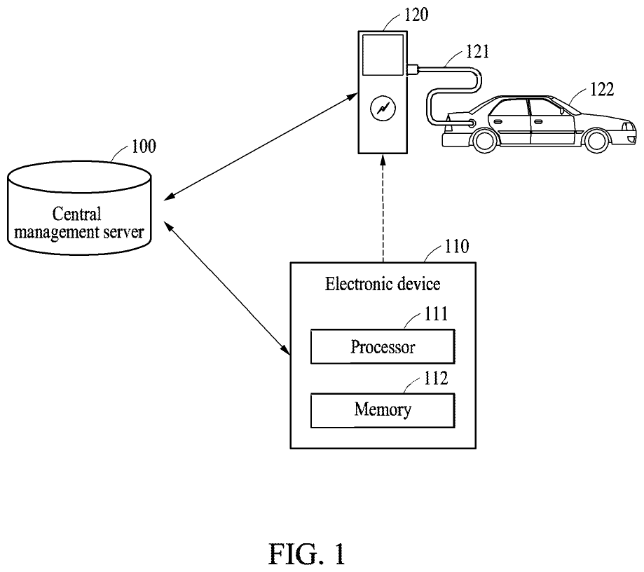

FIG. 1 is a diagram illustrating an electronic device according to an embodiment.

Referring to FIG. 1, a central management server 100, an electronic device 110, and a charger 120 are illustrated. The charger 120 may be a device including a man machine interface (MMI) of an input/output function, which is an embodiment of the electronic device 110. A charging target load device may be a load, which is a target to be charged. For example, an electric vehicle 122 may be the charging target load device to be charged. The electronic device 110 may be a device including an MMI of an input/output function.

According to an embodiment, the central management server 100 may connect to and communicate with the electronic device 110 and the charger 120. The central management server 100 may transmit data to and receive data from the electronic device 110 and the charger 120. For example, the central management server 100 may receive a profile related to a user's energy use, which is input to the electronic device 110 from the user.

According to an embodiment, the central management server 100 may use the profile related to a user's energy use and thus provide a charging time, which is required for charging completion of the charging target load device that the user desires to charge, and a charging demand, which is required for charging, through the electronic device 110 and the charger 120. The central management server 100 may use the profile related to a user's energy use and thus provide the user's average history, that is, a customer base line load (CBL), as the charging demand and the charging time. For example, the central management server 100 may provide the average charging time and the average charging demand over 10 days with respect to the electric vehicle 122, as the charging time and the charging demand of the electric vehicle 122. Alternatively, the central management server 100 may provide representative values of the charging target load device, as the charging time and the charging demand.

According to an embodiment, the central management server 100 may include a change rate calculation model. When there is a command to increase or decrease the charging time and the charging demand provided by the central management server 100, the central management server 100 may use the change rate calculation model to determine an increase rate or a decrease rate with respect to the charging time and the charging demand. The change rate calculation model may be a model trained to calculate a change rate according to an input of an increase button or a decrease button so as to reach a current charging time and a current charging demand that the user currently desires to choose with the minimum selection on the increase button or the decrease button. The central management server 100 may multiply the change rate by an initial value to thus determine the increase rate or the decrease rate.

For example, when there is a command to decrease the charging time, the central management server 100 may apply not an initial decrease rate of 10% according to one input of the decrease button but a decrease rate of 30%, which is obtained by multiplying the initial decrease rate of 10% by an increase rate of 3, which is determined by using the change rate calculation mode. That is, the user may have input the decrease button three times for the 30% decrease, but the central management server 100 may apply the 30% decrease with only one input of the decrease button, using the change rate calculation model, thus reaching the values that the user desires with the minimum button input.

The electronic device 110 may include a processor 111 and a memory 112. The processor 111 may execute software to control at least one other component (e.g., the memory 112) of the electronic device 110 connected to the processor 111 and may perform a variety of data processing or computations. For example, the processor 111 may use the change rate calculation model stored in the memory 112 to calculate the increase rate or the decrease rate according to the increase or decrease command of the user. The memory 112 may store a variety of data used by at least one component (e.g., the processor 111) of the electronic device 110. The variety of data may include, for example, software and input data or output data for instructions related to the software. The memory 112 may include a volatile memory or a non-volatile memory. For example, the memory 112 may store the change rate calculation model updated by the central management server 100.

The electronic device 110 may receive a command input from the user, using the MMI. The MMI of the electronic device 110 may be a physical button or a button displayed on a screen provided by an application and/or a web browser running on the electronic device.

The electronic device 110 may directly receive the user's desired charging time and charging demand, but it may be cumbersome to receive an input from the user for every charging. According to an embodiment, the electronic device 110 may receive an increase command, a determination command, or a decrease command from the user, through an increase button, a determination button, or a decrease button.

According to an embodiment, the electronic device 110 may collect a profile related to the user's energy use from the user through an application and/or a web browser. The electronic device 110 may transmit the collected profile to the central management server 100. According to an embodiment, the electronic device 110 may provide, to the user, the charging time and the charging demand, which are required for charging completion of the electric vehicle 122, through an application and/or a web browser. The charging time and the charging demand required for charging may be determined based on the profile.

According to an embodiment, when the charging time and the charging demand provided by the electronic device 110 are different from those desired by the user, the electronic device 110 may receive a command to increase or decrease the charging time and the charging demand from the user. When the charging demand and the charging time provided by the electronic device 110 are the same as those desired by the user, the electronic device 110 may receive, from the user, a charging command with the current charging demand and the current charging time through the button.

According to an embodiment, when the memory 112 of the electronic device 110 stores the change rate calculation model, the processor 111 of the electronic device 110 may calculate an increase rate or a decrease rate according to a command to increase or decrease the charging time or the charging demand, based on the change rate calculation model. Accordingly, the electronic device 110 may reach the charging time and charging demand desired by the user with the minimum selection with respect to the increase button or the decrease button.

According to an embodiment, when the memory 112 of the electronic device 110 does not store the change rate calculation model, the processor 111 of the electronic device 110 may transmit the received increase command or decrease command to the central management server 100. The central management server 100 receiving the increase command or the decrease command may calculate the increase rate or the decrease rate using the change rate calculation model.

According to an embodiment, when the electronic device 110 receives the determination command, the electronic device 110 may generate a charging start command.

According to an embodiment, when the electronic device 110 includes a charging interface 121, which may connect to a control module of a charging target load device, the electronic device 110 itself may charge the charging target load device according to the charging start command. For example, when the electronic device 110 is the charger 120 capable of charging the electric vehicle 122, the charger 120 itself may charge the electric vehicle 122.

According to an embodiment, when the electronic device 110 does not include the charging interface 121 that may connect to a control module of a charging target load device, the electronic device 110 may transmit the charging start command to the charger 120 interlocked with the electronic device 110. Upon receipt of the charging start command, the charger 120 may charge the charging target load device. For example, when the electronic device 110 is a smartphone that does not include the charging interface 121, the charging start command may be transmitted to the charger 120 interlocked with the smartphone and the charger receiving the charging start command through the charging interface may charge the electric vehicle 122.

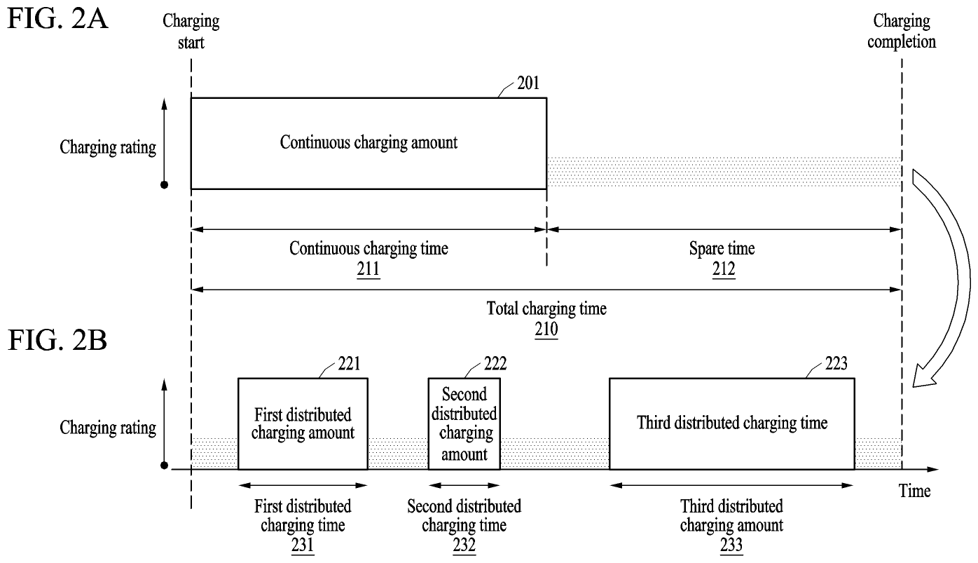

FIGS. 2A and 2B are diagrams illustrating distributed charging according to an embodiment.

FIG. 2A is a diagram illustrating continuous charging of a charging target load device. FIG. 2B is a diagram illustrating distributed charging of a charging target load device.

Referring to FIG. 2A, the charging target load device may be fully charged with a continuous charging amount 201 during a continuous charging time 211. A charging amount may be the product of a charging time and a charging rating. Accordingly, the continuous charging amount 201 may be the product of the charging rating and the continuous charging time 211. That is, the continuous charging amount 201 may be equal to an area that is the product of the charging rating and the continuous charging time 211. Although the charging target load device is fully charged, a time during which the charging target load device continues to be connected to a charger may be a spare time 212. The sum of the continuous charging time 211 and the spare time 212 may be a total charging time 210.

For example, it is assumed that an electric vehicle is connected to the charger at 8 pm and fully charged at 11 pm, and the electric vehicle is connected to the charger until 8 am the next day. In this case, the continuous charging time 211 may be 3 hours and the spare time 212 may be 9 hours. The total charging time 210 may be 12 hours.

When a period from 8 pm to 11 pm is a peak time when people use much electricity since people leave work during the period, the electric vehicle may need to be charged during a time other than the peak time.

Referring to FIG. 2B, the charging target load device may not be continuously charged but may be charged in a distributed manner. The charging target load device may be charged by as much as a first distributed charging amount 221 during a first distributed charging time 231. The charging target load device may be charged by as much as a second distributed charging amount 222 during a second distributed charging time 232. The charging target load device may be charged by as much as a third distributed charging amount 223 during a third distributed charging time 233.

The sum of the first distributed charging time 231, the second distributed charging time 232, and the third distributed charging time 233 may be the continuous charging time 211. The sum of the first distributed charging amount 221, the second distributed charging amount 222, and the third distributed charging amount 223 may be the continuous charging amount 201.

For example, although the electric vehicle is connected to the charger at 8 pm, the electric vehicle may be charged for 1 hour of the first distributed charging time 231 and 0.5 hours of the second distributed charging time 232, during the peak time from 8 pm to 11 pm. The electric vehicle may be charged for as much as 1.5 hours during a time other than the peak time, from 11 pm to 8 am the next day.

Accordingly, the burden on a power supply system may be reduced by reducing the charging of the charging target load during the peak time.

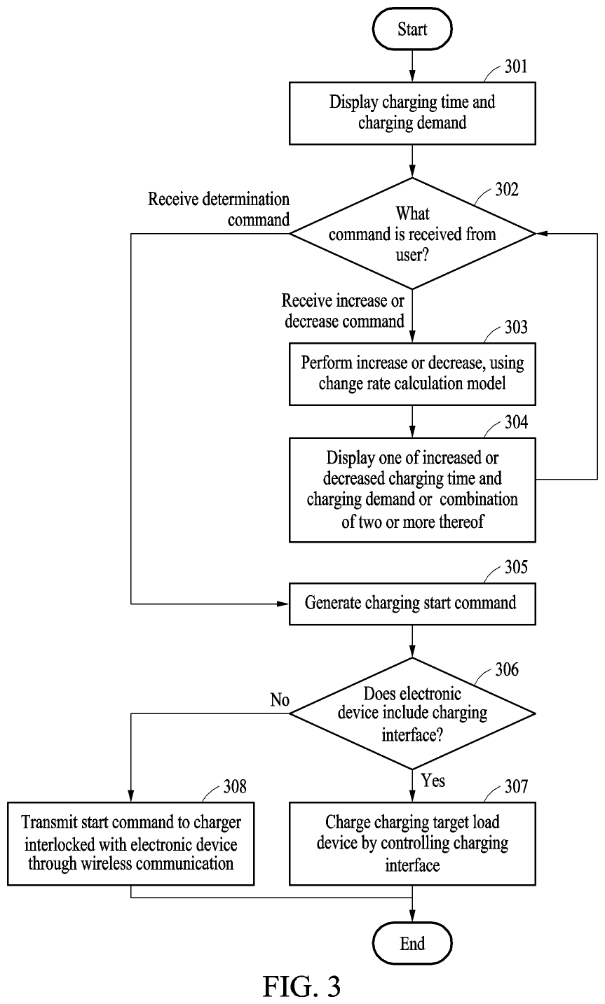

FIG. 3 is a flowchart illustrating an operation of an electronic device according to an embodiment.

Referring to FIG. 3, illustrated is an operating method of energy management of an electronic device in which a change rate calculation model is stored in memory.

In the following embodiments, operations may be performed sequentially, but not necessarily limited thereto. For example, the order of the operations may change and at least two of the operations may be performed in parallel. Operations 301 through 308 may be performed by a processor of the electronic device.

In operation 301, the processor may display a charging time and charging demand.

According to an embodiment, the processor may use a profile related to a user's energy use to display the charging time, which is required for charging completion of a charging target load device that the user desires to charge, and the charging demand, which is required for charging. The profile related to energy use may be a history of a time used to charge the user's charging target load device and of a charging amount used to charge the charging target load device for a certain period of time.

According to an embodiment, the charging time may be the total charging time of FIG. 2. The charging demand may be the sum of the distributed charging amounts or the continuous charging amount in FIG. 2.

According to an embodiment, the processor may collect the profile related to energy use from the user. The processor may transmit the collected profile related to the energy use to a central management server. The central management server may determine the charging time required for charging completion of a charging target load device, which is an electronic device that a user desires to charge, and the charging demand required for charging, based on the received profile. The central management server may transmit the determined charging demand amount and charging time to the electronic device. The electronic device may display the received charging demand and charging time.

In operation 302, the processor may receive a command for the charging time and the charging demand from the user. The command may include an increase command, determination command or a decrease command. The processor may receive, from the user, the command for one of the charging time and the charging demand or a combination of two or more thereof. For example, the processor may receive the increase command for the charging time and the decrease command for the charging demand.

According to an embodiment, the processor may receive, from the user, an increase command, a determination command, or a decrease command for one of the charging time and the charging demand or a combination of two or more thereof, through an increase button, a determination button, or a decrease button.

According to an embodiment, when one of the charging time and the charging demand or a combination of two or more thereof, which is displayed by the processor, is less than values that the user desires to select, the processor may receive the increase command from the user. For example, when the charging time provided by the processor is 9 hours, the processor may receive the decrease command through the decrease button and thus decrease the charging time.

According to an embodiment, when one of the charging time and the charging demand or a combination of two or more thereof, which is displayed by the processor, is greater than values that the user desires to select, the processor may receive the decrease command from the user. For example, when the charging demand provided by the processor is 10 kWh, the processor may receive the increase command through the increase button and thus increase the charging demand to 15 kWh.

In operation 303, when the processor receives the increase command or the decrease command, the processor may use the change rate calculation model to increase or decrease one of the charging time and the charging demand or a combination of two or more thereof.

According to an embodiment, the processor may calculate a change rate, using the change rate calculation model stored in the memory and may calculate an increase rate or a decrease rate by multiplying an initial value by the change rate. The initial value may be a predetermined value, regardless of the change rate calculation model. Regardless of the change rate calculation model, the initial value may be a predetermined increase rate or a predetermined decrease rate that is generated by an input of the increase button or decrease button. For example, the initial value may be 10%, which is the predetermined increase or the predetermined decrease rate that is generated by the input of the increase button or the decrease button, regardless of the change rate calculation model.

According to an embodiment, the processor may increase or decrease one of the charging time and the charging demand or a combination of two or more thereof, by as much as the calculated increase rate or the calculated decrease rate. The processor may use the increase rate or the decrease rate calculated based on the change rate so as to reach the charging time and charging demand that the user desires to select, with the minimum input of the increase button or the decrease button.

For example, when a 30% decrease in the charging time is required to reach the charging time that the user desires to select, the processor may need three inputs of the decrease button according to an initial value of 10%. However, when a decrease rate based on the change rate calculated by using the change rate calculation model is 30%, the processor may reach the charging time that the user desires to select, with one input of the decrease button.

In operation 304, the processor may display one of an increased or decreased charging time and an increased or decreased charging demand or a combination of two or more thereof. In operation 303, the processor may display one of the increased or decreased charging time and the increased or decreased charging demand or a combination of two or more thereof, according to the increase rate or the decrease rate.

Operations 302 through 304 may be repeatedly performed until the processor receives a determination command.

In operation 305, upon receipt of the determination command, the processor may generate a charging start command. The processor may generate the charging start command for charging according to a current charging time and a current charging demand.

According to an embodiment, when the current charging time and the current charging demand are the charging time and the charging demand that the user desires to select, the processor may receive the determination command.

According to an embodiment, when the processor does not receive the increase command or the decrease command before receiving the determination command, the current charging time and the current charging demand may be the charging time and the charging demand displayed by the processor in operation 301. When the processor does not receive the increase command or the decrease command before receiving the determination command, the current charging time and the current charging demand may be the charging time and the charging demand for the charging target load device, which are generated based on the user's profile.

According to an embodiment, when the processor receives the increase command or the decrease command before receiving the determining command, the current charging time and the current charging demand may be values in which one of the charging time and the charging demand or a combination of two or more thereof is increased or decreased by the increase rate or the decrease rate.

In operation 306, when the electronic device includes a charging interface that may be connected to a control module of a charging target load device, operation 307 may be performed. When the electronic device does not include the charging interface that may be connected to the control module of the charging target load device, operation 308 may be performed by transmitting a command through wireless communication to the charger interlocked with the electronic device.

In operation 307, the processor may charge the charging target load device by controlling the charging interface according to the charging start command. For example, when the electronic device is a charger (e.g., the charger 120 in FIG. 1) that performs an MMI function including the charging interface, the charger may control the charging interface according to the charging start command to charge the charging target load device. The processor may charge the charging target load device according to a current charging time and a current charging demand.

In operation 308, the processor may transmit the charging start command to the charger interlocked with the electronic device through wireless communication. The charging start command may include information about the current charging time and the current charging demand. For example, when the electronic device is a smartphone that does not include the charging interface, the smartphone may transmit the charging start command to the charger interlocked with the smartphone through wireless communication. Upon receipt of the charging start command, the charger may charge the charging target load device through the charging interface.

According to an embodiment, the electronic device may receive information about feedback from the user after performing operations 301 to 308. After performing operations corresponding to operation 301 to operation 308, the electronic device may display a screen to receive feedback. The electronic device may collect the information about the feedback on the operations from the user by displaying the screen to receive the feedback. For example, when the electronic device reaches the charging time or the charging demand that the user desires to select finally after five button inputs, the electronic device may receive negative feedback from the user. The information about the feedback collected by the electronic device may be used for updating the change rate calculation model later.

According to an embodiment, the electronic device may collect the number of button inputs the user makes to reach the current charging time or the current charging demand. The current charging time and the current charging demand may be the charging time or the charging demand that the user desires to select. For example, when three button inputs are made to reach the current charging time or the current charging demand, the electronic device may collect the number of button inputs. The number of button inputs collected by the electronic device may be used for updating the change rate calculation model afterward.

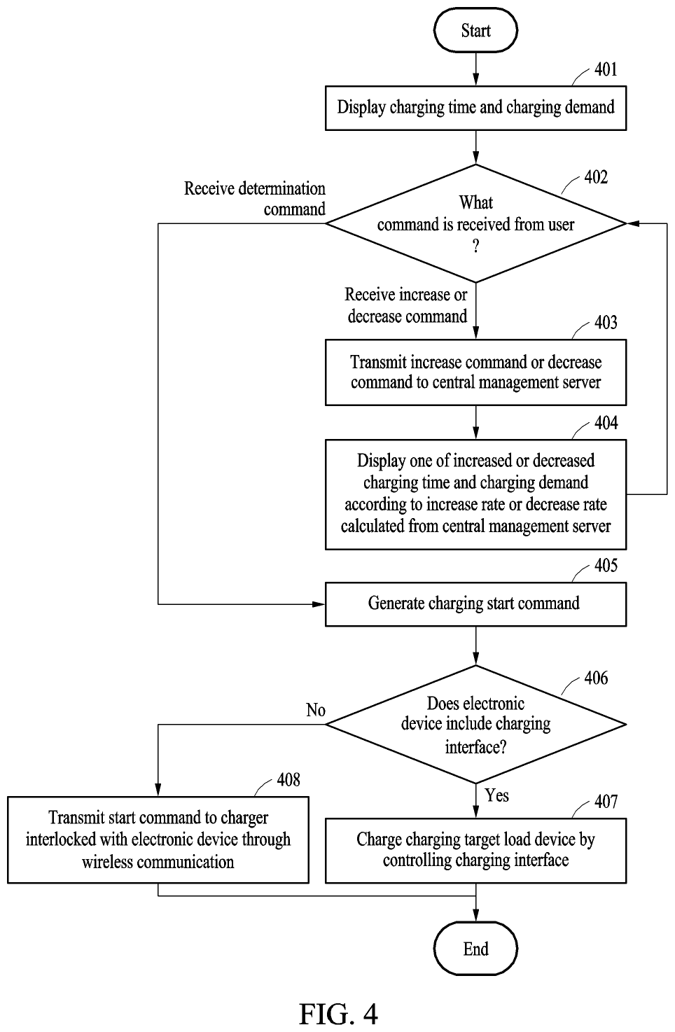

FIG. 4 is a flowchart illustrating an operation of an electronic device according to an embodiment.

Referring to FIG. 4, when a central management server stores a change rate calculation model, an operating method of energy management of the electronic device is illustrated.

In the following embodiments, operations may be performed sequentially, but not necessarily limited thereto. For example, the order of the operations may change and at least two of the operations may be performed in parallel. Operations 401 through 408 may be performed by a processor of the electronic device.

In operation 401, the processor may display a charging time and a charging demand. Since operation 401 is substantially the same as operation 301, a description thereof is omitted.

In operation 402, the processor may receive a command for the charging time and the charging demand from the user. Since operation 402 is substantially the same as operation 302, a description thereof is omitted.

In operation 403, the processor may transmit a received increase command or a received decrease command to a central management server.

According to an embodiment, the central management server may include a change rate calculation model. The central management server may increase or decrease one of the charging time and the charging demand or a combination of two or more thereof according to the increase command or the decrease command based on an increase rate or decrease rate calculated by using the change rate calculation model. The increase rate or decrease rate may be a value obtained by multiplying an initial value by a change rate calculated by the change rate calculation model. For example, when the initial value is −10% and the change rate is 0.8, the decrease rate may be 8%.

According to an embodiment, the central management server may transmit, to the electronic device, one of an increased or decreased charging time and an increased or decreased charging demand or a combination of two or more thereof according to the increase rate or the decrease rate calculated by using the charge rate calculation model.

In operation 404, the processor may display the increased or decreased charging time and the increased or decreased charging demand according to the increase rate or the decrease rate calculated by the central management server.

Operations 402 to 404 may be repeatedly performed until the processor receives a determination command.

In operation 405, upon receipt of the determination command, the processor may generate a charging start command. The processor may generate the charging start command for charging according to a current charging time and a current charging demand. Since operation 405 is substantially the same as operation 305, a description thereof is omitted.

In operation 406, when the electronic device includes a charging interface that may be connected to a control module of a charging target load device, operation 407 may be performed. When the electronic device does not include the charging interface that may be connected to the control module of the charging target load device, operation 408 may be performed by transmitting a command through wireless communication.

In operation 407, the processor may charge the charging target load device by controlling the charging interface, according to the charging start command. Since operation 407 is substantially the same as operation 307, a description thereof is omitted.

In operation 408, the processor may transmit the charging start command to a charger interlocked with the electronic device through wireless communication. Since operation 408 is substantially the same as operation 308, a description thereof is omitted.

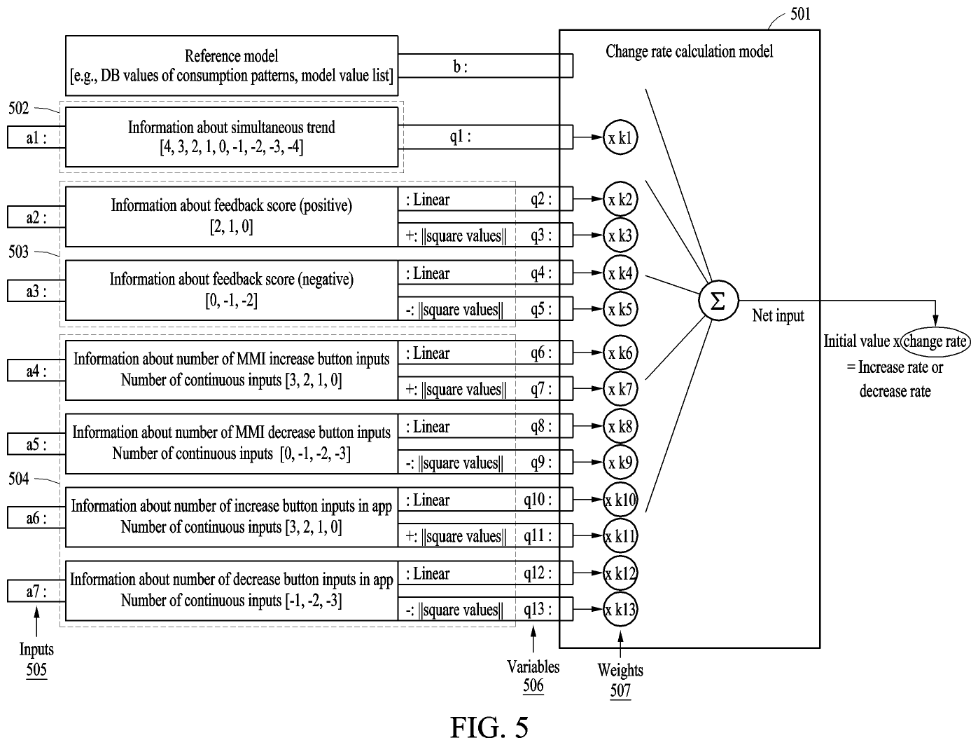

FIG. 5 is a diagram illustrating a change rate calculation model according to an embodiment.

Referring to FIG. 5, a change rate calculation model 501 is illustrated.

According to an embodiment, the change rate calculation model 501 may be a trained artificial intelligence model. The change rate calculation model 501 may calculate a change rate to determine an increase rate or a decrease rate for a charging time and a charging demand. A value obtained by multiplying an initial value by the change rate may be an increase rate or a decrease rate. The initial value may be an initial increase value or an initial decrease value according to an input of an increase button or a decrease button, regardless of the change rate calculation model 501. For example, the initial value may be an increase value of 10% or a decrease value of 10% according to one input of the increase button or the decrease button to which the change rate calculation model 501 is not reflected.

According to an embodiment, the change rate calculation model 501 may be a trained model for calculating the change rate to determine the increase rate or the decrease rate, so that the charging time and the charging demand that the user desires to select may be reached, with the minimum input of the increase button or the decrease button. The change rate calculation model 501 may be a reinforcement learning model trained to reach the charging time and charging demand that the user desires to select, with only one input, which is the minimum input. However, the change rate calculation model 501 is not limited to the reinforcement learning model and may be a model learned by various learning methods.

According to an embodiment, the change rate calculation model 501 may be a model that learns weights 507 to reach the charging time and charging demand that the user desires to select, with the minimum input of the increase button or the decrease button. According to an embodiment, when the change rate calculation model 501 is included in an electronic device (e.g., the electronic device 110 of FIG. 1), the change rate calculation model 501 may include the weights 507, which are pre-learned. Alternatively, when the change rate calculation model 501 is included in an electronic device (e.g., the electronic device 110 of FIG. 1), whenever the electronic device operates, the change rate calculation model 501 may learn the weights 507, which are pre-learned from a central management server (e.g., the central management server 100 of FIG. 1). The change rate calculation model 501 may be a model that learns the weights 507 differently for each user.

According to an embodiment, the change rate calculation model 501 may calculate the change rate by using the weights 507. The weights 507 may include k1 to k13.

According to an embodiment, k1 may be a weight interlocked with information 502 about a simultaneous trend. The information 502 about a simultaneous trend may be information about a charging time and a charging demand of other users who are charging an electronic device of the same type as the charging target load device that the user desires to charge at the same time. For example, when the user desires to charge the electric vehicle, the information 502 about a simultaneous trend may be information about a charging time and a charging demand of other users charging the electric vehicle at the same time.

According to an embodiment, the information 502 about a simultaneous trend may be used to train the change rate calculation model 501. The information 502 about a simultaneous trend for training the change rate calculation model 501 may be determined based on a profile related to the user's energy use. The information 502 about a simultaneous trend for training the change rate calculation model 501 may be the information 502 about a simultaneous trend for a time similar to the user's energy use time according to the profile related the user's energy use. For example, when the user charges the charging target load device mainly from 9 pm to 9 am the next day, the information 502 about a simultaneous trend for training the change rate calculation model 501 may be information about a charging time and a charging demand of the other users who charge an electronic device of the same type as the electronic device that the user desires to charge from 9 pm to 9 am the next day.

According to an embodiment, k2 to k5 may be weights for information 503 about a feedback score. k2 and k3 may be weights related to a positive evaluation in the information 503 about a feedback score. k4 and k5 may be weights related to a negative evaluation in the information 503 about a feedback score. The information 503 about a feedback score may be feedback information collected from the user after the electronic device uses the change rate calculation mode 501 and thus provides a service of reaching the charging time and the charging demand desired by the user, with the minimum button input. The electronic device of managing energy may provide a survey for collecting feedback information from the user after providing the service to the user.

According to an embodiment, the information 503 about a feedback score according to a survey result may be used to train the change rate calculation model 501.

According to an embodiment, k6 to k13 may be weights related to information 504 about the number of button inputs. The information 504 about the number of button inputs may be information about the number of inputs of a decrease button or an increase button to reach the charging time and the charging demand that the user desires to select. k6 to k9 may be weights related to information about the number of inputs of the increase button or the decrease button using an MMI. k6 and k7 may be weights related to the number of inputs of the increase button, using the MMI. k8 and k9 may be weights related to the number of inputs of the decrease button, using the MMI. k10 to k13 may be weights related to the number of inputs of the increase button or the decrease button in an app. k10 and k11 may be weights related to the number of inputs of the increase button in the app. k12 and k13 may be weights related to the number of inputs of the decrease button in the app.

According to an embodiment, the information 504 about the number of button inputs may be information about the number of inputs of the increase button or the number of inputs of the decrease button, which are made to reach the charging time and the charging demand that the user desires to select and may be used for training the change rate calculation model 501.

According to an embodiment, the change rate calculation model 501 may calculate the change rate by adding a reference model value b to the product of k1 to k13 of the weights 507 and variables 506 corresponding to k1 to k13. The change rate calculation model 501 may calculate the change rate by putting inputs 505 into the variables 506 and adding the reference model value to the product of the variables 506 and the weights 507 corresponding to the inputs 505, respectively. That is, it may be Change rate=b+Σₙ₌₁¹³q(n). b may denote the reference model value. q(n) may denote the variables 506. k(n) may denote trained weights. The variables q(1), q(2), q(4), q(6), q(8), q(10), and q(12) may be values obtained by simply putting the inputs a1, a2, a3, a4, a5, a6, and a7. The variables q(3), q(7), and q(11) may be values obtained by putting the square values of the inputs a2, a4, and a6 corresponding to the variables q(3), q(7), and q(11). The variables q(5), q(9), and q(13) may be values obtained by putting a minus value to the square value of the inputs a3, a5, and a7 corresponding to the variables q(5), q(9), and q(13).

According to an embodiment, the reference model value b may vary depending on a reference model. The reference model may be various predetermined models. For example, the reference model may include a standard model based on an office worker who charges a charging target load device from 9 pm to 7 am the next day. For example, the reference model may include a standard model based on an office worker who works a shift in which the charging pattern of a charging target load device is not regular.

According to an embodiment, the change rate calculation model 501 may be re-learned and updated at regular intervals. When the number of button inputs, which is to reach one of the charging time and the charging demand that the user desires to select or a combination of two or more thereof, exceeds a specific threshold, the change rate calculation model 501 may be learned and updated again.

Hereinafter, a method in which the change rate calculating model 501 calculates a change rate is described based on a flowchart.

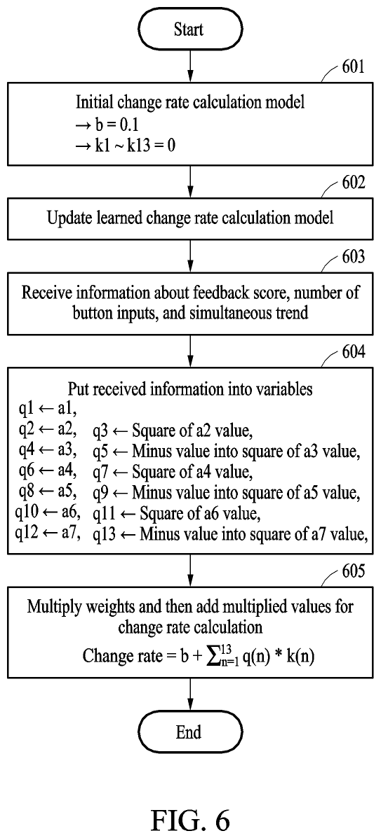

FIG. 6 is a diagram illustrating an operation of a change rate calculation model according to an embodiment.

Referring to operation 601, the change rate calculation model 501 may include a change rate calculation model 501 before being learned. A reference model value b of the change rate calculation model 501 before being learned may be determined to be 0.1. k1 to k13, which are the weights 507 of the change rate calculation model 501 before being learned, may be determined to be 0.

Referring to operation 602, the change rate calculation model 501 may be updated to the change rate calculation model 501, which is learned. An electronic device 110 may receive, from a central management server 100, the change rate calculation model 501, which is learned, and update the change rate calculation model 501. Accordingly, the reference model value b may be updated. k1 to k13 of the weights 507 may be updated.

According to an embodiment, the electronic device 110 may update and store the change rate calculation model 501 for which learning has been completed and may use the change rate calculation model 501 when necessary. According to an embodiment, the electronic device 110 may store the change rate calculation model 501 before being learned and, only when necessary, update and use the change rate calculation model 501, which is learned, from the central management server 100.

Referring to operation 603, the change rate calculation model 501 may receive information 503 about a feedback score, information 504 about the number of button inputs, and information 502 about a simultaneous trend, from the central management server 100.

Referring to operation 604, the change rate calculation model 501 may put the information received from the central management server 100 into the variables 506 of the updated change rate calculation model 501. For example, the electronic device 110 may put the information 502 about a simultaneous trend into the variable q1 related thereto. The electronic device 110 may put the information 503 about a feedback score into the variables q2 to q5 related thereto. The electronic device 110 may put the information 504 about the number of button inputs into the variables q6 to q13 related thereto.

According to an embodiment, the variables q1, q2, q4, q6, q8, q10, and q12 may be values obtained by putting the inputs a1, a2, a3, a4, a5, a6, and a7 corresponding thereto, as they are. The variables q3, q7, and q11 may be values obtained by putting the square values of the inputs a2, a4, and a6 corresponding to the variables q3, q7, and q11. The variables q5, q9, and q13 may be values obtained by putting a minus value into the square of the inputs a3, a5, and a7 corresponding to the variables q5, q9, and q13.

In operation 605, the change rate calculation model 501 may calculate a change rate by multiplying the weights 507 updated by the variables 506, into which the information received from the central management server 100 is put, respectively, and adding the multiplied value to the reference model value b, which is updated. That is, it may be Change rate=b+Σₙ₌₁¹³q(n)*k(n)

According to an embodiment, a value obtained by multiplying an initial value by the change rate calculated by the change rate calculation model 501 may be an increase rate or a decrease rate. The initial value may be an initial increase value or an initial decrease value according to an input of an increase button or a decrease button, regardless of the change rate calculation model 501. For example, when the initial increase value for an increase in the charging time and the charging demand is 10%, three inputs of the increase button may be required for a 30% increase. However, when the increase rate, to which the change rate calculated by the change rate calculation model 501 is applied, is 30%, a 30% increase may be achieved by one input of the increase button. Accordingly, the charging time and charging demand that the user desires to select may be reached with a minimum button input.

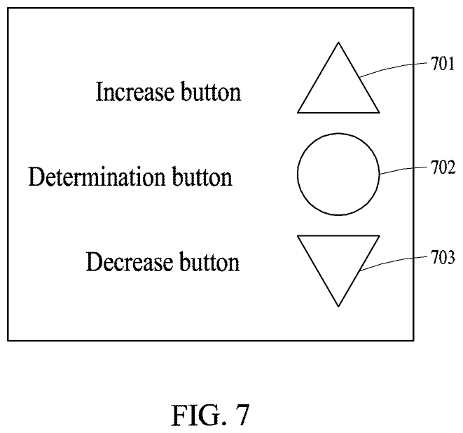

FIG. 7 is a diagram illustrating a button capable of receiving a command from a user, according to an embodiment. Referring to FIG. 7, an increase button 701, a determination button 702, and a decrease button 703 are shown.

According to an embodiment, the increase button 701, the determination button 702, and the decrease button 703 may be physical buttons. According to an embodiment, the increase button 701, the determination button 702, and the decrease button 703 may be buttons including an image displayed on the screen of an electronic device 110 executing an energy management application.

According to an embodiment, the electronic device 110 may receive, from a user, an increase command for one of a charging time and a charging demand or a combination of two or more thereof through the increase button 701. Upon receipt of the increase command, the electronic device 110 may determine an increase rate according to the increase command, using a change rate calculation model 501. For example, upon receipt of the increase command, the electronic device 110 may calculate a change rate according to the flowchart shown in FIG. 6 and determine the increase rate based on the change rate.

According to an embodiment, the electronic device 110 may receive, from the user, a decrease command for one of the charging time and the charging demand or a combination of two or more thereof through the decrease button 703. Upon receipt of the decrease command, the electronic device 110 may determine a decrease rate according to the decrease command, using the change rate calculation model 501. For example, upon receipt of the decrease command, the electronic device 110 may calculate a change rate according to the flowchart shown in FIG. 6 and determine the decrease rate based on the change rate.

According to an embodiment, the electronic device 110 may receive a determination command from the user through the determination button 702. Upon receipt of the determination command, the electronic device 110 may generate a charging start command for charging a charging target load device according to a current charging time and a current charging demand.

According to an embodiment, when the increase command or the decrease command is received before receiving the determination command, the current charging time and the current charging demand may be an increased value or a decreased value according to the increase command or the decrease command for one of the charging time and the charging demand or a combination of two or more thereof, based on a profile.

According to an embodiment, when the increase command or the decrease command is not received before receiving the determination command, the current charging time and the current charging demand may be the charging time and the charging demand, based on the profile.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductive wire memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned embodiments is required for all the embodiments, and it should be understood that the aforementioned program components and apparatuses may be integrated into a single software product or packaged into multiple software products.

The embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed embodiments, can be made.

What is claimed is:

1. An operating method of an electronic device, the operating method comprising:
displaying a charging time, which is required for charging completion of a charging target load device that a user desires to charge, and a charging demand, which is required for charging, by using a profile related to energy use of the user;
receiving, from the user, an increase command, a determination command, or a decrease command for one of the charging time and the charging demand or a combination of two or more thereof, through an increase button, a determination button, or a decrease button;
when a received command is the increase command or the decrease command, performing an increase or a decrease in one of the charging time and the charging demand or the combination of two or more thereof, according to the increase command or the decrease command, based on an increase rate or a decrease rate using a change rate calculated through a change rate calculation model; and
when a received command is the determination command, generating a charging start command to charge the charging target load device, according to a current charging time and a current charging demand.

2. The operating method of claim 1, wherein the current charging time and the current charging demand are:
when the increase command or the decrease command is received before receipt of the determination command, values in which one of the charging time and the charging demand or the combination of two or more thereof is increased or decreased by the increase rate or the decrease rate; and
when the increase command or the decrease command is not received before receipt of the determination command, the charging time and the charging demand, respectively.

3. The operating method of claim 1, wherein the change rate calculation model is a learned model to calculate the change rate according to an input of the increase button or an input of the decrease button so as to reach the current charging time and the current charging demand that the user desires to select, with a minimum selection with respect to the increase button or the decrease button.

4. The operating method of claim 1, wherein the change rate calculation model is a learned model to calculate the change rate according to an input of the increase button or an input of the decrease button, with an input of information about a feedback score, information about a number of button inputs, and information about a simultaneous trend.

5. The operating method of claim 4, wherein
the information about the feedback score is feedback information received from the user after the electronic device performs the operating method,
the information about the number of button inputs is information about a number of inputs of the increase button or a number of inputs of the decrease button to reach the current charging time and the current charging demand that the user desires to select, and
the information about the simultaneous trend is information about the charging time and the charging demand of other users who charge a load device of a same type as the charging target load device that the user desires to charge at a same time.

6. The operating method of claim 1, wherein the change rate calculation model is a learned model from a central management server communicating with the electronic device and a model in which the learned model is upgraded to the electronic device.

7. The operating method of claim 4, wherein the performing of the increase or the decrease comprises:
receiving the information about the feedback score, the information about the number of button inputs, and the information about the simultaneous trend;
inputting the information about the feedback score, the information about the number of button inputs, and the information about the simultaneous trend to the change rate calculation model;
calculating the increase rate or the decrease rate by multiplying an initial value by the change rate, which is a result value that the charge rate calculation model outputs according to an input, wherein the initial value is a predetermined value to perform an increase or a decrease in one of the charging time and the charging demand or a combination of two or more thereof, under the increase command or the decrease command, regardless of the change rate calculation model; and
performing an increase or a decrease under the increase command or the decrease command according to the increase rate or the decrease rate.

8. The operating method of claim 1, wherein the profile related to the energy use of the user is a history of a time used for charging the charging target load device of the user during a specific period and of a charging demand used for charging the charging target load device.

9. The operating method of claim 1, further comprising, when the electronic device comprises a charging interface connected to a control module of the charging target load device and the electronic device is connected to the charging target load device through the charging interface, charging the charging target load device according to the charging start command.

10. The operating method of claim 1, further comprising, when the electronic device does not comprise a charging interface connected to a control module of the charging target load device, transmitting the charging start command to a charger interlocked with the electronic device,
wherein the charger receiving the charging start command is configured to charge the charging target load device connected to the charger.

11. An electronic device comprising:
a memory comprising a change rate calculation model; and
a processor configured to:
display a charging time, which is required for charging completion of a charging target load device that a user desires to charge, and a charging demand, which is required for charging, by using a profile related to energy use of the user;
receive, from the user, an increase command, a determination command, or a decrease command for one of the charging time and the charging demand or a combination of two or more thereof, through an increase button, a determination button, or a decrease button;
when a received command is the increase command or the decrease command, perform an increase or a decrease in one of the charging time and the charging demand or a combination of two or more thereof, according to the increase command or the decrease command, based on an increase rate or a decrease rate using a change rate calculated by the change rate calculation model; and
when a received command is the determination command, generate a charging start command to charge the charging target load device according to a current charging time and a current charging demand.

12. The electronic device of claim 11, wherein
the current charging time and the current charging demand are,
when the increase command or the decrease command is received before receipt of the determination command, values in which one of the charging time and the charging demand or the combination of two or more thereof is increased or decreased by the increase rate or the decrease rate; and
when the increase command or the decrease command is not received before receipt of the determination command, the charging time and the charging demand, respectively.

13. The electronic device of claim 11, wherein the change rate calculation model is a learned model to calculate the change rate according to an input of the increase button or an input of the decrease button so as to reach the current charging time and the current charging demand that the user desires to select, with a minimum selection with respect to the increase button or the decrease button.

14. The electronic device of claim 11, wherein the change rate calculation model is a learned model to calculate the change rate according to an input of the increase button or an input of the decrease button, with an input of information about a feedback score, information about a number of button inputs, and information about a simultaneous trend.

15. The electronic device of claim 14, wherein
the information about the feedback score is feedback information received from the user according to an operation of the electronic device,
the information about the number of button inputs is information about a number of inputs of the increase button or a number of inputs of the decrease button to reach the current charging time and the current charging demand that the user desires to select, and
the information about the simultaneous trend is information about the charging time and the charging demand of other users who charge a load device of a same type as the charging target load device that the user desires to charge at a same time.

16. The electronic device of claim 11, wherein the change rate calculation model is a learned model from a central management server communicating with the electronic device and a model in which the learned model is upgraded to the electronic device.

17. The electronic device of claim 14, wherein the processor is configured to:
receive the information about the feedback score, the information about the number of button inputs, and the information about the simultaneous trend, from a central management server communicating with the electronic device;
input the information about the feedback score, the information about the number of button inputs, and the information about the simultaneous trend to the change rate calculation model;
calculate the increase rate or the decrease rate by multiplying an initial value by the change rate, which is a result value that the change rate calculation model outputs according to an input, wherein the initial value is a predetermined value to perform an increase or a decrease in one of the charging time and the charging demand or a combination of two or more thereof, under the increase command or the decrease command, regardless of the change rate calculation model; and
perform an increase or a decrease under the increase command or the decrease command according to the increase rate or the decrease rate.

18. The electronic device of claim 11, wherein the profile related to the energy use of the user is a history of a time used for charging the charging target load device of the user during a specific period and of a charging demand used for charging the charging target load device.

19. The electronic device of claim 11, wherein, when the electronic device does not comprise a charging interface connected to a control module of the charging target load device, the processor is configured to:
transmit the charging start command to a charger interlocked with the electronic device; and
the charger receiving the charging start command is configured to charge the charging target load device connected to the charger.

20. An electronic device comprising:
a memory comprising a change rate calculation model; and
a processor configured to:
display a charging time, which is required for charging completion of a charging target load device that a user desires to charge, and a charging demand, which is required for charging, by using a profile related to energy use of the user;
receive, from the user, an increase command, a determination command, or a decrease command for one of the charging time and the charging demand or a combination of two or more thereof, through an increase button, a determination button, or a decrease button;
when a received command is the increase command or the decrease command, transmit the increase command or the decrease command to a central management server communicating with the electronic device; and
when a received command is the determination command, generate a charging start command to charge the charging target load device, according to a current charging time and a current charging demand,
wherein the model management server is configured to, when the increase command or the decrease command is received from the electronic device, calculate a change rate, using a change rate calculation model, to reach the current charging time and the current charging demand, which the user desires to select, with a minimum selection of the increase button or the decrease button.
